(19) United States
(12) Patent Application Publication
(10) Pub. No.: US 2020/0088061 A1
(43) Pub. Date: Mar. 19, 2020

(54) EXTERNAL AUTOMATED BRAKING SYSTEM FOR RAIL-BASED VEHICLES

(71) Applicant: Jerry W. Polanich, Davis, CA (US)

(72) Inventor: Jerry W. Polanich, Davis, CA (US)

(21) Appl. No.: 16/571,069

(22) Filed: Sep. 14, 2019

Related U.S. Application Data
(60) Provisional application No. 62/732,571, filed on Sep. 17, 2018.

(51) Int. Cl. F01D 15/10; B61K 13/00; F15B 1/02; F02C 1/02

(52) U.S. Cl. CPC F01D 15/10; B61K 13/00; B61H 9/06; F02C 1/02; F15B 1/024

(57) ABSTRACT

A railroad powered energy cogeneration system and method comprising a plurality of air compressor hoses, a plurality of manifold pipelines, at least one manifold pipeline check valve, a pneumatic air filter, a pneumatic motor-generator set, and a pressure control valve, wherein the plurality of manifold pipelines is configured to connect each of the plurality of air compressor hoses attached to an inner side of each of the rails of an existing railroad system. The plurality of air compressor hoses produces compressed air when a train traverses over them. The at least one manifold pipeline check valve is configured to assure unidirectional air flow through the plurality of manifold pipelines. The pneumatic motor-generator set converts compressed air into electricity and the remaining compressed air is stored in the storage vault and/or other storage means described.

### RELATED APPLICATIONS

This application claims priority from the United States provisional application with Ser. No. 62/732,571 and filed Sep. 17, 2018, the disclosure of which is incorporated herein as if set out in full.

### BACKGROUND OF THE DISCLOSURE

### Technical Field of the Disclosure

The present embodiment relates in general to power generating systems associated with rail vehicles and, in particular, to a railroad powered cogeneration system and related air compression hose to produce a large volume of compressed air, and even more specifically to a system for slowing rail-based vehicles and converting linear kinetic energy at optimum locations along normal grade level track to provide macro pneumatic utility capacity quantities of energy.

### Description of the Related Art

There is probably no single industry on Earth that has anywhere near as large of a direct and/or indirect impact on our daily economic lives than the energy industry. Nearly all of modern society relies on energy, and while most is electric, the energy sources are myriad from which modern industrial electricity is derived. One unexpected but highly functional source for storing energy is compressed air. Relatedly, railroads and their tracks traverse 233,000 miles of territory in the United States alone. They serve the vital role of interconnecting major cities, providing a convenient and cost-effective means of transportation for both people and goods.

As noted in U.S. Pat. No. 10,079,524 granted to Jerry Polanich, it may be efficient and economical to employ air compressors that do not require electrical energy for their operation, particularly when a plurality of compressor units, pipelines and storage systems are configured to receive their energy inputs from the mechanical forces exerted by passing trains. The '524 patent describes systems producing large volumes of compressed air and utilizing transportation systems that are already in place. Although the described system provides a reliable supply of compressed air that can be stored for extended lengths of time and used for industrial purposes as well as electrical generation, several improvements to the system are needed.

While the '524 patent is based on the application of the first part of Newton's 1st law, there is a need to capitalize on the second part of the same law in order to further the pursuit towards zero carbon emission, sustainable energy recovery and immediate storage systems. Specifically, at the terminal end of the railroad lines described in the '524 patent, kinetic energy of a fast-moving train must be reduced to substantially zero as the train comes to a stop at a given rail station or other stopping point or stretch of track where the train might otherwise apply its brakes.

### SUMMARY OF THE DISCLOSURE

To minimize the limitations found in the existing systems and methods, and to minimize other limitations that will be apparent upon the reading of this specification, the preferred embodiment of the present invention provides a dynamic high energy force transfer system as a part of an energy recovery system. The dynamic high energy force transfer system is a railroad powered energy recovery system that produces a large volume of compressed air and generates electricity utilizing the compressed air.

The system comprises a plurality of air compressor hoses, a plurality of manifold pipelines, at least one manifold pipe check valve, a pneumatic air filter, a pneumatic motor-generator set, at least one pressure control valve, a storage means and a second storage means laterally placed adjacent to each track rail's easements. The plurality of air compressor hoses is attached to an inner side of each of the rails of a railroad. The plurality of manifold pipelines connect the plurality of air compressor hoses along the length of the rail which includes an air outlet at one end. The air filter captures free air from the atmosphere and supplies it to at least one of the plurality of air compressor hoses.

It is another objective of the invention to provide a sustainable energy source where the only energy medium involved is air.

It is another objective of the invention to improve safe energy storage, distribution and to increase national security through the creation of multiple micro-grids.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a schematic diagram of an air compression hose according to a preferred embodiment of the invention;

FIG. 2 depicts other attributes, qualities, and examples of an air compression hose according to the preferred embodiment of the invention;

FIG. 3 depicts various views of a track and ACH according to the preferred embodiment of the invention;

FIG. 4 depicts a cross sectional view of an ACH on a track rail according to a preferred embodiment of the invention;

FIG. 5 depicts a plain view of ACH air discharge lines and a track, and lower in this figure is a cross sectional front view of the same;

FIG. 6 is at top an overhead view and at lower is an inside rail cross section view of the ACH gap section and associated manifold pipeline connections associated with the preferred embodiment of the invention;

FIG. 7 depicts an overhead view of a rail with train, and associated ACH and air pneumatic compression tanks;

FIG. 8 depicts a cogeneration system including a side view of underground compressed air storage; and

FIG. 9 depicts a cogeneration system with rubber tread cap engaged by a train wheel flange.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below

As used herein, the singular forms “a”, “an” and “the” include plural referents unless the context clearly dictates otherwise. “And” as used herein is interchangeably used with “or” unless expressly stated otherwise. As used herein, the term “about” means +/−5% of the recited parameter. All embodiments of any aspect of the invention can be used in combination, unless the context clearly dictates otherwise.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein”, “wherein”, “whereas”, “above”, and “below” and the like refer to the present application as a whole, and not to any particular embodiments of the application.

In the prior art, Air Compression Units (ACUs) 102 have been shown to provide an efficient supply of compressed air sourced from the weight of trains passing on a track. In operation, as the train moves over the rails of the railroad, the wheel of the train touches the fully recoiled air compressor hose and compresses at least one of the plurality of air compressor hoses 102. The compression of each of the plurality of air compressor hoses 102 occurs during normal train trip operations and does not interfere with normal train operations. However, at the terminal end of a train line, or indeed any time a train must reduce its speed and hence kinetic energy, an additional system may be used.

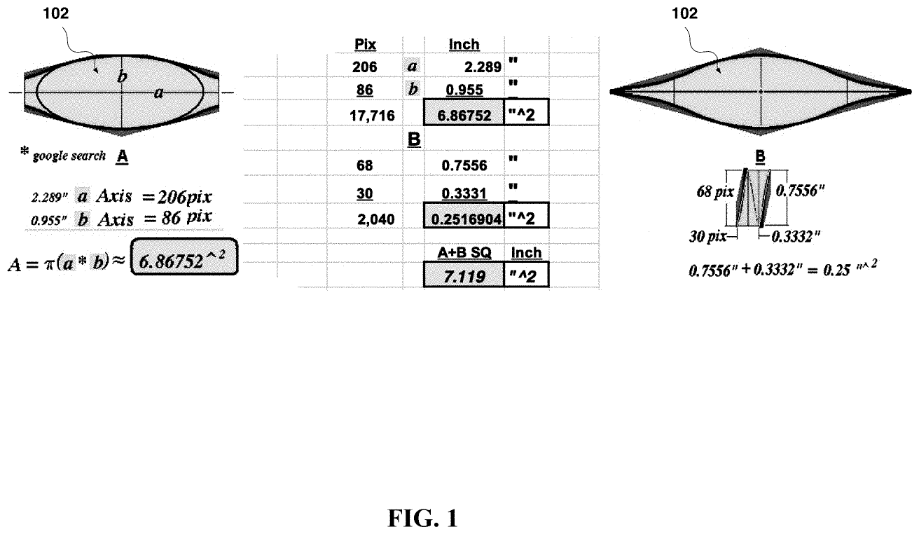

Turning first to FIG. 1, a schematic diagram an Air Compression Hose 102 section. The calculations and measurements shown herein and with respect to this entire patent application as a hole are merely exemplary calculations and may by modified without departing from the spirit of the invention. Other versions of the invention may employ parts of varying size and strength and may produce varying amounts of compressed air at different levels of compression depending on the needs of the installation. For example, in one version of the invention, the flat spring steel enables an enhanced operating air pressure. In one embodiment, because flat spring steel or the like adds significantly to the strength of the rubber hosing, an enhanced operating air pressure of up to or above 300 psi may be achieved. In addition, a net target 280 psi mean effective pressure or greater may be achieved in some embodiments. At 280 psi mean effective pressure, an 18 cylinder embodiment of the herein described invention may be expected to output above 64,300 kWh on a 24/7 basis.

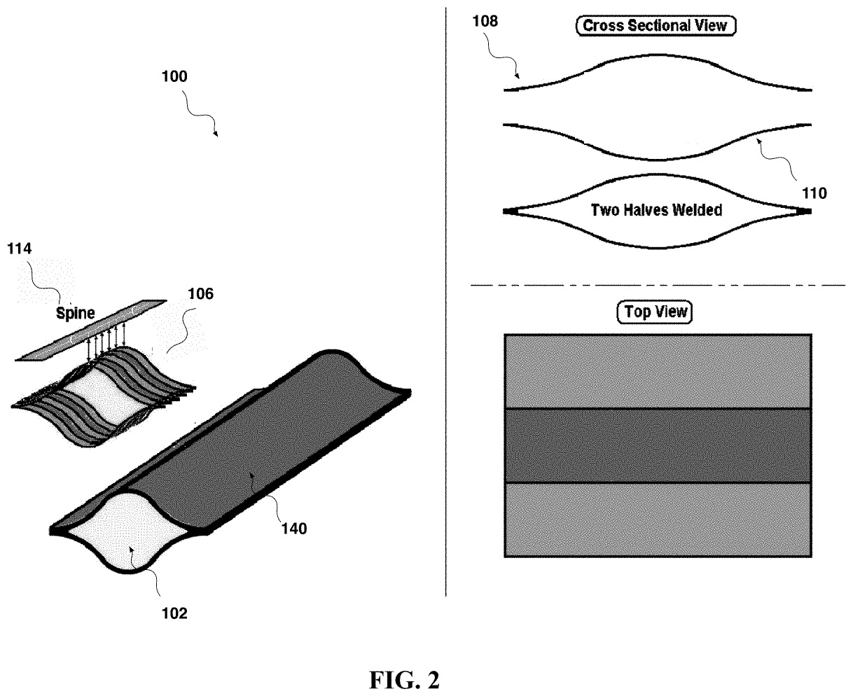

Referring to FIG. 2, in the preferred embodiment leaf spring ribs 106, including one upper half leaf spring rib 108 and one lower half leaf spring rib 110, are bound together by end caps 112 and riveted to form a seal between the upper half leaf spring rib and the lower half leaf spring rib. As disclosed herein, a wide range of configurations for various parts of the present invention are contemplated by the inventor. Therefore, specific embodiments and configurations, as described above, are not to be construed as limiting the scope of the present invention.

Referring to FIG. 2, a spine 114 is depicted, which is preferably spot welded and attached centered to each leaf spring 106 on the bottom half only and at a right angle as shown. In the preferred embodiment, alternating leaf springs 110 may be arranged at regular spacings in order to accommodate flexibility and width expansion during compression. For example, as depicted in FIG. 2, alternating 1 inch wide leaf springs 110 of 0.018 inch thickness may be spaced at 1 inch intervals, said spacings arranged so as to facilitate flexibility and width expansion during compression as the train wheels roll over said leaf springs 110. In other embodiments, the spine 114 may be modified to improve surface characteristics. For example, in one embodiment the spine 114 may comprise a non-slip spine 115 so as to optimize the frictional coefficient between the non-slip spine and the leaf spring 106. Further embodiments of the present invention may employ components of varying size and strength thus permitting a wide range of potential compression states, each compression state tunable to its unique environment.

Referring to FIG. 2, as the train wheels carry their freight car loads the opposing leaf springs 106 (Black lines inside a thicker blue set of lines) inside its laminated rubber Compressed Air Hose 102 walls collapse under the weight of train wheel crossing over them. This forms a progressive seal along that path so that no air will escape in front of them except for what is being displaced. As a column of increasing air pressure forms in front of those rolling wheels in the hose, its destination will only end up routed to its closest manifold intersection, (Red). Transfer of a train's rolling wheel force starts with contact between those train wheels and the top of the Rubber Hose Cap Tread (Slate blue)(“Sponge Bob”) surfaces' 19″ radius leading flange edge intersection,

Where (a standard wheel flange is 3⅜″ wide and extends 1″ below the Rail Head top wheel contact surface). This is the critical measurement constant that makes the entire difference in both volume of air displaced, but also the force to resistance ratio as a train accelerates, cruises or slows down that is so dramatically affected by Newton's 1st law of motion and a train's mass.

Then, behind each wheel, the hose recoils, drawing free air from behind them with a vacuum force determined by the spring metal strength and after each wheel set finishes crossing their respective, (total) 12.25′ length span of an Air Compression Hose (ACH) section. The difference between total ACH length and effective ACH length is the 2″ space at the beginning and end of the two 90 degree pipes attach the ACH and their respective Bench Seats. Here is where “U” shaped muffler type hold down clamps fasten those sections.

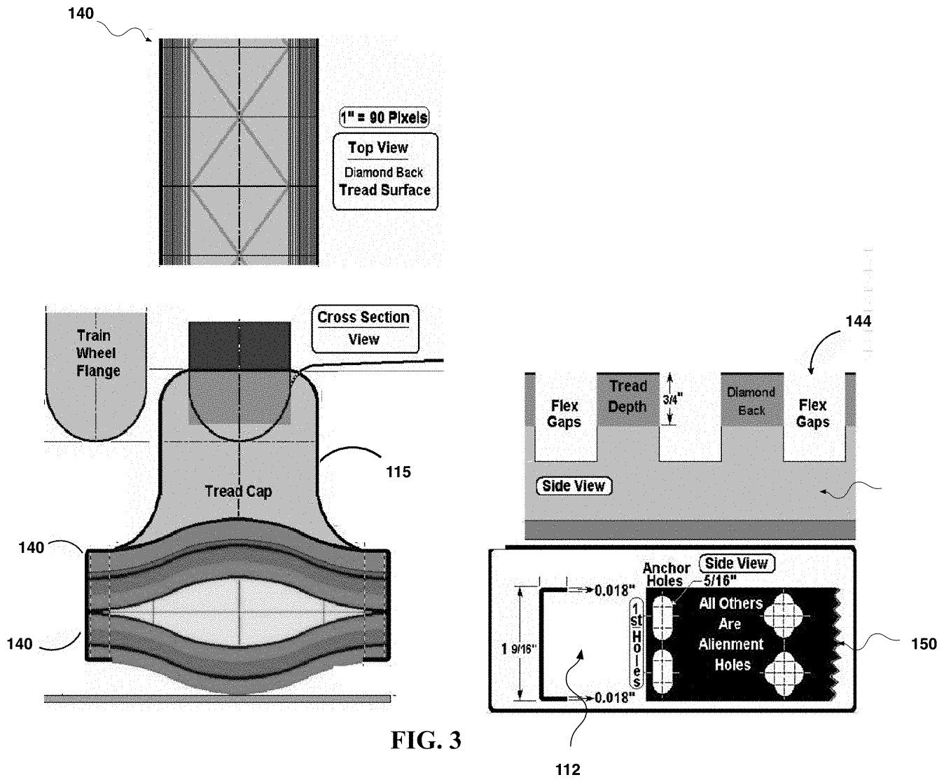

Referring to FIG. 3, laminated rubber layers 140 are depicted in dark grey. In the preferred embodiment, the laminated rubber layers 140 are composed of a skin, airtight covering, integument or the like. Such a covering enhances the efficiency of compressed air storage and transfer over a range of compression states. Referring further to FIG. 3, end caps 112 are depicted, the end caps 112 operably bound to the rubber layer open end(s) of the laminated rubber layer(s) 140. Finally, end cap rivets of the end caps 112 are shown to fasten the “C” channel spring(s) to the laminated rubber layer(s) 140. In some embodiments, the use of end caps is not required and in fact may increase the structural integrity of the system. To this end continuous hinges, such as piano hinges, are arranged and/or bonded in a side by side fashion. Notably, piano hinges may be constructed of various thicknesses, pin diameters, and may be manufactured with or without holes. In one embodiment, as described above, a side by side arrangement of piano hinges may be achieved by inserting the piano hinges onto and over the top of an ACH discharge hose. Advantageously, this embodiment permits a simplified construction by eliminating the requirement to bond the hinges together.

FIG. 3 also depicts tread caps 115, which are bounded to the top layer of the laminated rubber as per the illustration and forms the energy transfer segments used to receive the force from a train wheel rolling over them. Each 1″ segment is centered directly over a 1″ wide Leaf Spring Rib when they are all bound together in the mold forming process, similar to the conventional manufacturing techniques used for automobile tires. Tread cap spaces are also shown here, and they provide the flexibility to allow effortless strain relief when the train wheels roll over the tread caps. A steel belt is sandwiched between layers of rubber as shown in the illustration, and finally anchor and anchor holes are present, which serve to attach 3.25′ sections of ACH to its supporting member below, referred to herein as a bench seat. As illustrated in FIG. 3, multiple components may comprise ARC's air compression hose frame layers.

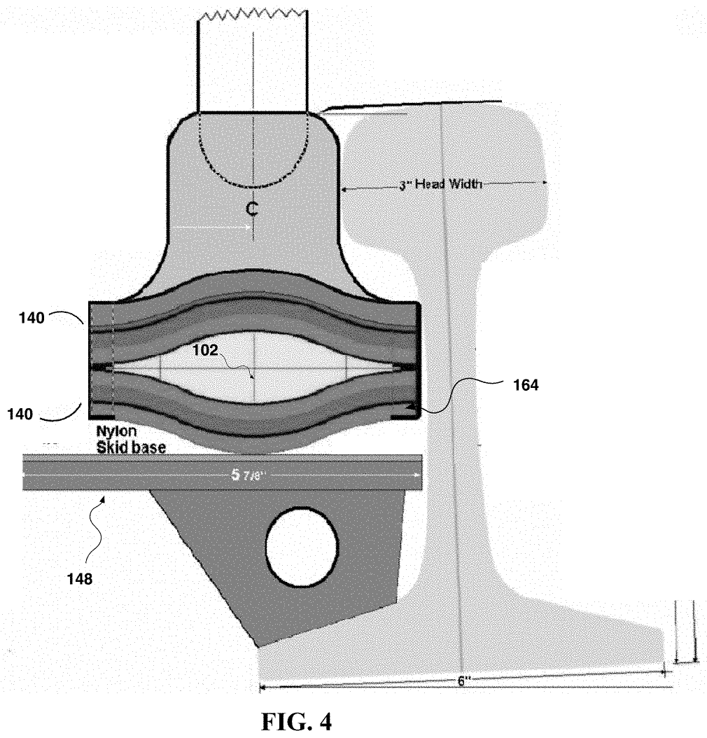

FIG. 4 shows the bench 148 and supporting members in more detail. In the preferred embodiment the bench 148 comprises ⅜″ carbon steel, which forms the full-length support system for the ACH sections as per the illustration. Nylon prevents premature wear between the bottom rubber ACH layer and bench 148. In some embodiments, the lower spring steel segments may be spot-welded or similarly affixed to a bench. Further, the lower spring steel segments may be aligned so that a train wheel flange individually actuates from the rolling wheel force to each individual upper spring steel segment through a their end caps,’

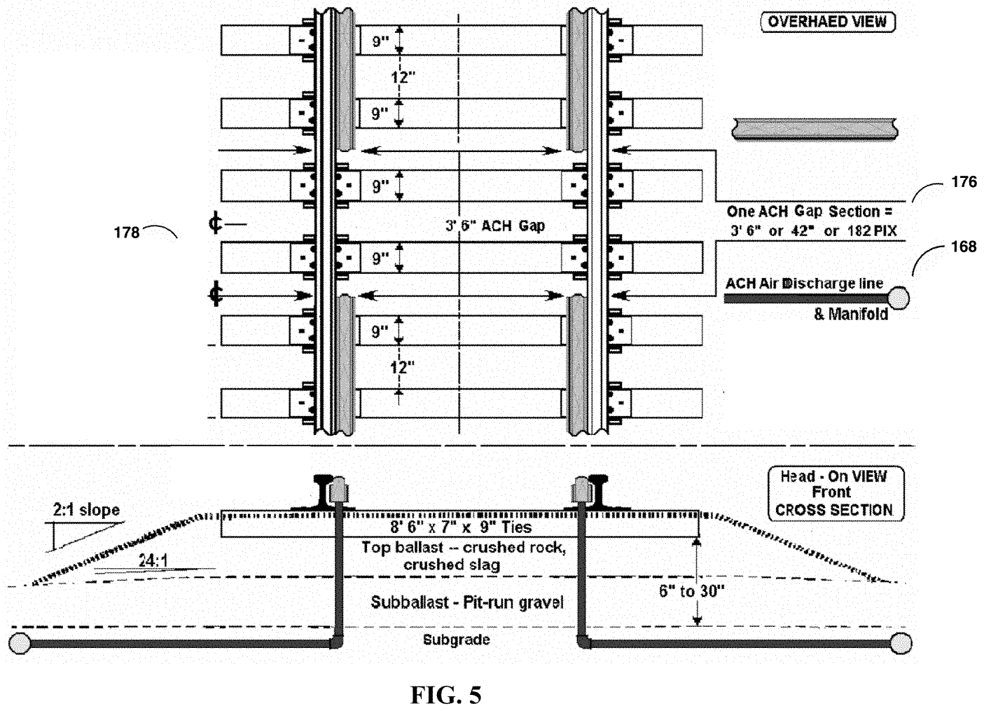

FIG. 5 shows discharge lines 168, which move the compressed air to the manifold pipeline as shown in the illustration. The tab also shows discharge line adapter fittings, which connect the “eye shape” air flow in an ACH to a round shaped discharge line. Discharge line adapter fitting clamps such as those manufactured by Victaulic® may be used to complete the coupling of the fittings to the discharge lines.

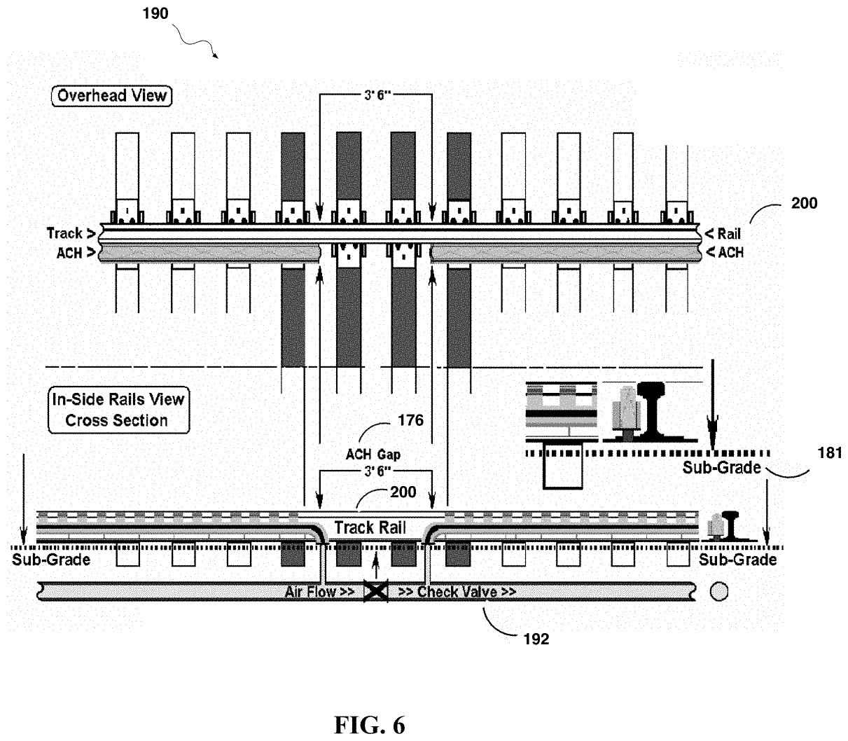

FIG. 6 depicts top an overhead view and at lower an inside rail cross section view of the manifold gap section 176 and associated manifold pipeline connections associated with the preferred embodiment of the invention. The manifold pipeline is the main supply line utilized to distribute compressed air from the alternating sections of the ACH 102. As discussed, such Manifold pipeline check valves 192 are positioned strategically between the manifold gap sections 176. Compressed air flow can only travel into the designated storage vaults near the railroad tracks from which they come.

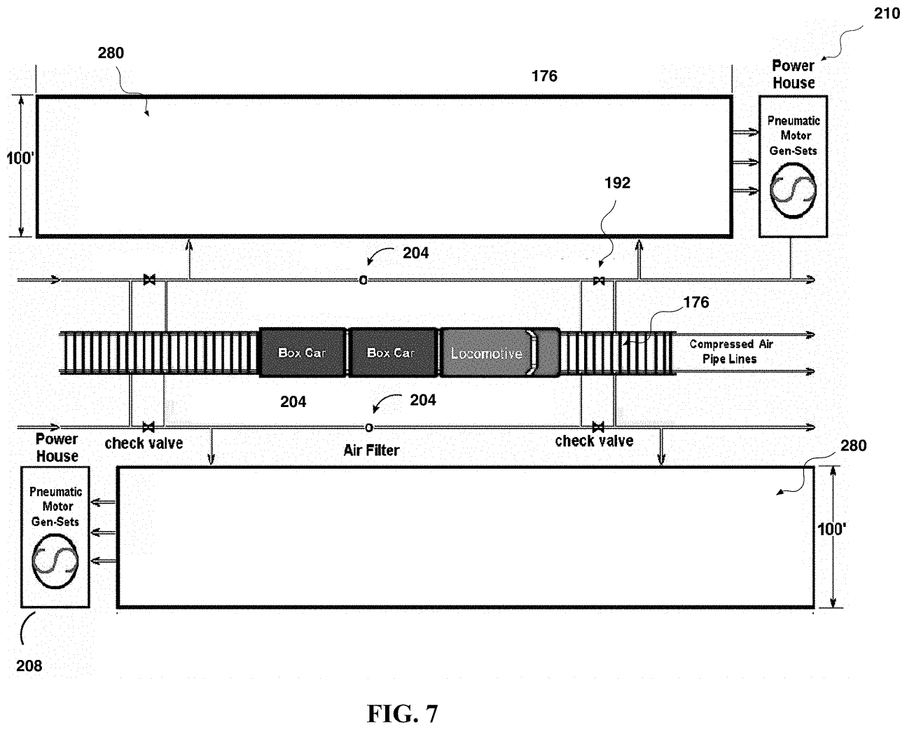

Turning next to FIG. 7, storage vaults 280 are depicted. As discussed above, compressed air is stored in storage vaults until the potential energy therein is needed and released on demand. In use, compressed air is distributed from the ACH to storage vaults 280. Storage vaults 280 are preferably located underground, and may include terminal storage vaults generally located near a city's limit and in proximity to its Train Depot or alternatively near any other region of track where a train typically applies its brakes, such as descending a mountain or near commercial freight customers typically on sites between towns and cities. Power stations 210 comprise a housing within which multiple pneumatic motor-generator connected banks and controls exist. Preferably the power station is located near the storage vault 280, and serves to convert the compressed air energy into electrical energy on an as needed basis.

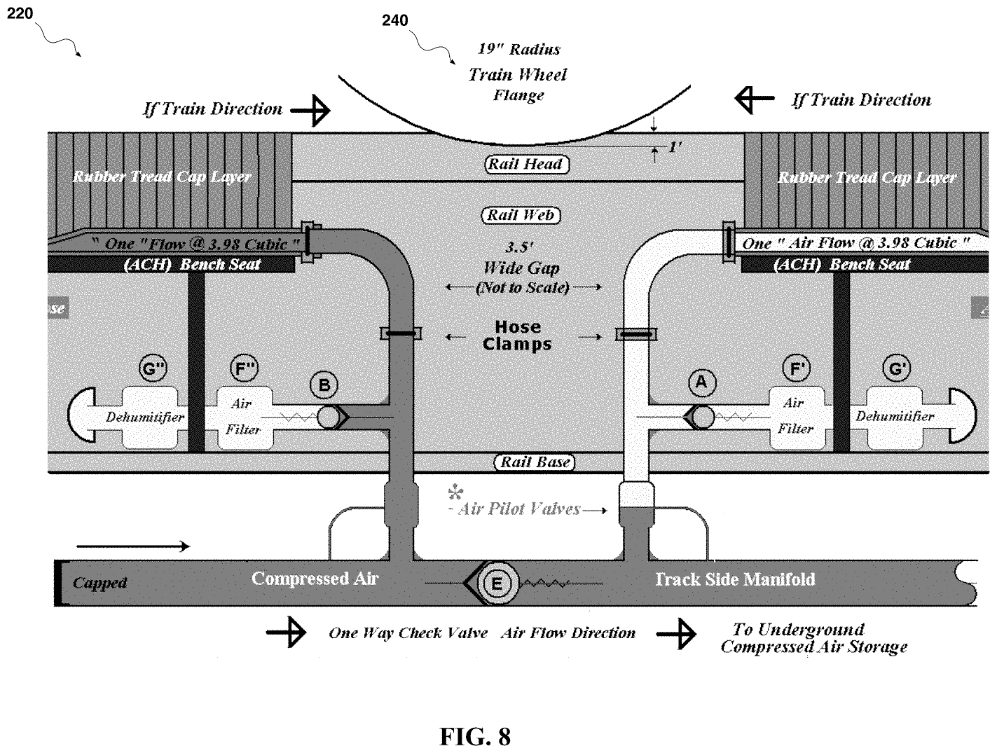

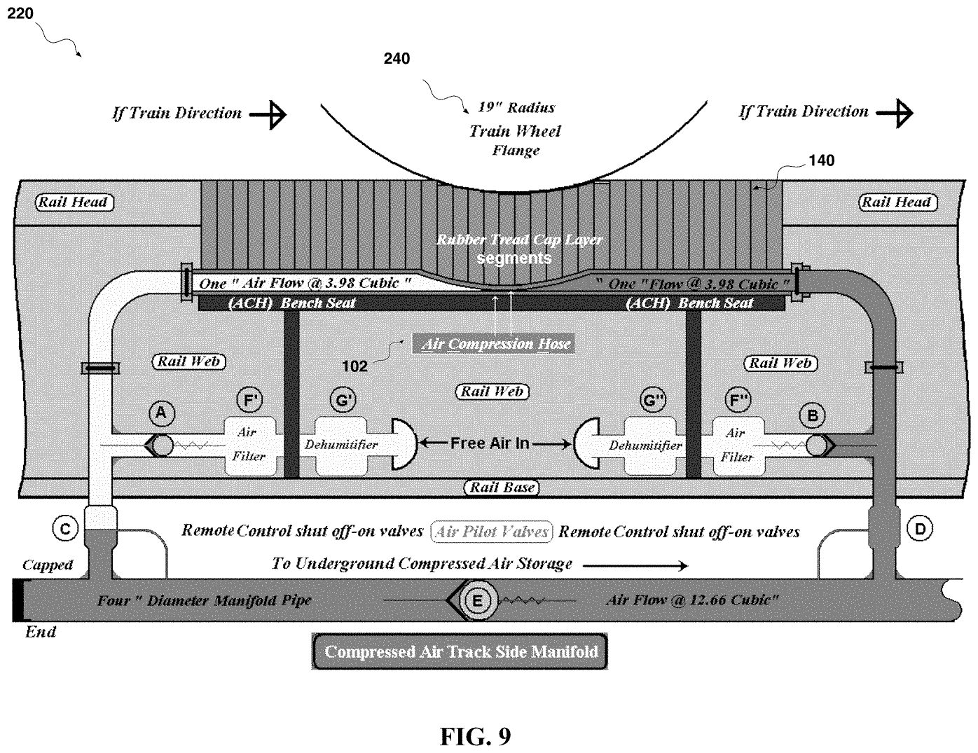

FIG. 8 and FIG. 9 illustrate the track side manifold pipeline 220, including a side view of underground compressed air storage. In the preferred embodiment, the train wheels 240 compress air and displace it under said train wheels 240, resulting in the full compression hose air capacity to be deposited into the lateral track side manifold pipeline 220. In the preferred embodiment, the lateral diameter track side manifold 220 is 4″ in diameter and runs in an accessible covered trench parallel to its track rail.

The system may further strategically deliver energy directly to storage before use in order to avoid losing what had initially just been generated. Furthermore, the system may harvest energy using RPCS pneumatic installations as a means to slow down and stop trains at rail stations typically found it the midst of cities they serve as a means of maximizing the efficiency of the compressed air storage resource. Here, resistance is a plus and does not reduce locomotive MPG fuel consumption.

Added benefits of the invention are to improve national security using Micro Grids with RPCS power stations located on the city limits where it will service those communities directly and where the energy demands are the greatest, thus, reducing the need for high voltage line to perform the same energy delivery function. The initial size is utility scale, preferably matches a city's total electrical peak capacity future demands with supply for 10-year planning. The system may utilize optional National Grid connection relays to create redundancy and add system demand flexibility. Unlike existing steam generating power plants that need nearly a full day to announce how much electricity it can forecast delivering to the ISO/grid, electricity generated by pneumatic motor generator sets can throttle up or down as needed to meet demand.

Although the system has been described with respect to slowing a train before bringing it to a full stop, any other large conveyance, such as elevators or amusement park rides, which must be brought to a stop, is ripe for application by the details of this invention.

The ACH system described herein is capable of providing reliable On-Demand massive volumes of compressed air that it can then deliver to nearby underground storable energy tanks where it can then be supplies large bank of pneumatic motor/generator sets to produce powerplant scale clean electricity. With government sustainable and renewable mandated goals already in place, public utility companies are required to buy electricity from those sources under typically 20 or 30 year term contracts.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

The railroad powered energy cogeneration system 100 is particularly adapted to be integrated with existing rails of the railroad. The present system 100 produces on-demand massive volumes of compressed air and this compressed air is utilized to generate electricity. The present system 100 can be installed on rails of the railroad, without causing any interference to their normal operation. This system 100 utilizes the energy of a train in motion to produce a clean and sustainable energy supply on demand. The system 100 of the present invention replaces the usage of fossil fuels and eliminates the discharge of hydrocarbons or other harmful byproducts into the atmosphere. The system 100 converts mass weight in motion using pneumatic components with greater efficiency to produce highly compressed air. The compressed air is utilized for distinctly different applications like, a source for pneumatic systems in industrial applications and generating electricity from the compressed air.

The present system 100 provides an efficient supply of compressed air directly to the industrial user at a full operating scale volume and according to demand needs on site. The present system can economically provide mega-cubic feet supply of compressed air from the large underground storage units. More preferably, compressed air may be deposited into naturally occurring underground cavities or man made abandon wells that were once used to extract water or oil & natural gas. The system 100 may also produce “Utility Scale Electricity” when it is exclusively connected to a national grid system.

The railroad powered energy cogeneration system comprises a plurality of air compressor hoses 102, a plurality of pipelines, at least one check valve, an air filter 204, a motor-generator set, at least one pressure regulator valve, a first storage means and a second storage means 50. The rail of the existing railroad is positioned over a number of tie plates (not shown) and held in position utilizing a number of couplings each having an inside bracket (not shown) and an outside bracket (not shown). The rails 154 thus connected using the inside bracket and the outside bracket creates a gap therebetween.

The plurality of air compressor hoses is attached to the inner side of each of the parallel rails of the existing railroad utilizing an attachment means. The attachment means includes a channel bracket connector adapter and a mounting channel iron connector. The channel bracket connector adapter fits into the mounting channel iron connector which is attached to the air compressor hose 102. One end of the channel bracket connector adapter is then inserted into the gap formed between the rail and the inside bracket on inner side of the railroad and is held firmly. The plurality of air compressor hoses 102 is arranged in series along the length of the rail and positioned adjacent the rail head and placed over the rail base. The plurality of air compressor hoses 102 is arranged such that when the train traverses over it, the train wheel flange touches the top of the air compressor hoses, push it downwards and compress the air compressor hoses 102. Each of the plurality of air compressor hoses 102 is interconnected by means of the plurality of pipelines. The plurality of pipelines is configured to provide a path for the passage of air into and out of the air compressor hose. The present system 100 produces large volumes of compressed air at the air outlet of the at least one of the plurality of pipelines.

In one embodiment, a plurality of compressed air storage means could be employed to store compressed air to produce electricity and designated for the exclusive supply of compressed air in accordance with the air demand needs.

The present system provides a rather large potential accumulation of compressed air volume available on-demand in the first storage means and the second storage means. Instead of very large diesel engines, the present system employs a pneumatic motor-generator set that is air started and which can efficiently operate exclusively by air pressure alone. Thus, electricity can then be cleanly produced without relying on the conventional heat energy of expanding diesel fuel combustion gases to drive pistons down during engine power strokes. The energy recovery nature of the present system 100 provides sustainable, reliable on-demand massive volumes of both compressed air and from compressed air delivered to the first storage means and the second storage means, produces power plant capacity scale amounts of clean electricity. The present system 100 eliminates the need for heat, water, sunlight, wind energy or a direct source of fossil fuel to produce electricity.

The railroad powered cogeneration system 100 generated electricity is capable of being delivered both for base-load or peaking demand power demands. When load spikes occur, the system 100 can rapidly throttle up and down to serve both typically separate power source types. The system employs power management design techniques to manage demand with on-demand electrical power controls.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A railroad powered cogeneration system, comprising:
a. a plurality of air compressor hoses attached to an inner side of each of the rails of an existing railroad system;
b. a plurality of manifold pipelines configured to connect each of the plurality of air compressor hoses, at least one of the plurality of manifold pipelines includes a pneumatic air outlet;
c. at least one manifold pipeline check valve configured to assure unidirectional air flow;
d. a pneumatic air filter attached to at least one of the plurality of manifold pipelines;
e. pneumatic motor-generator set connected to a storage vault of the at least one of the plurality of manifold pipelines, the storage vault to store the compressed air; and
f. at least one pressure control valve to control the pressure of air through the plurality of manifold pipelines;
g. whereby when a train moves over the railroad, the wheels of the train compresses the plurality of air compressor hoses to produce compressed air which is supplied to the pneumatic motor-generator set to generate electricity.

2. The railroad powered energy cogeneration system of claim 1 wherein each of the plurality of air compressor hoses comprises:
a. an air compressor housing having a leaf spring assembly including an upper leaf spring and a lower leaf spring forming an enclosed assembly;
b. a rubber tread cap layer;
c. remote control shut off-on valves; and
d. a discharge line to move compressed air to the manifold pipe.

3. The railroad powered energy recovery system of claim 2 wherein the tread cap member provides protection to the air compressor hose.

4. The railroad powered energy recovery system of claim 2 wherein the inlet and the outlet are configured to transfer air into and out of the air compressor hose.

5. The railroad powered energy recovery system of claim 1 wherein the plurality of manifold pipelines provides a path for the passage of air therethrough.

6. The railroad powered energy recovery system of claim 1 wherein the air inlet is configured to supply free air into at least one of the plurality of manifold pipelines and the pneumatic air outlet forces compressed air from at least one of the plurality of air compressor hoses to flow out of the only in one restricted direction through the manifold pipeline.

7. The railroad powered energy recovery system of claim 1 wherein the pneumatic air filter is configured to capture and supply free air from the atmosphere to at least one of the plurality of air compressor hose.

8. A railroad powered energy cogeneration system to generate electricity from compressed air, the system comprising:
a. a plurality of air compressor hoses attached to an inner side of each of the rails of an existing railroad system, each of the plurality of air compressor hoses comprising;
b. a plurality of manifold pipelines configured to connect each of the plurality of air compressor hoses, the plurality of manifold pipelines providing a path for the passage of air therethrough;
c. at least one manifold pipeline check valve configured to assure consistent direction of air flow; and
d. a first storage means connected to the pneumatic air outlet of the at least one of the plurality of manifold pipelines to store the compressed air; and whereby when a train moves over the railroad, the wheels of the train compress the plurality of air compressor hoses to produce compressed air which is supplied to the pneumatic motor-generator set to generate electricity and the remaining compressed air is stored in the first storage means and the second storage means for industrial purposes.

9. The railroad powered energy cogeneration system of claim 8, wherein a pneumatic air filter attached to the air inlet of at least one of the plurality of manifold pipelines, the pneumatic air filter configured to capture and supply free air from the atmosphere to at least one of the plurality of air compressor hoses.

10. The railroad powered energy cogeneration system of claim 8, wherein a pneumatic motor-generator set connected to the pneumatic air outlet of the at least one of the plurality of manifold pipelines, the pneumatic motor-generator set configured to generate electricity from compressed air.

11. The railroad powered energy cogeneration system of claim 8, wherein at least one pressure control valve controls the pressure of air through the plurality of manifold pipelines.

12. The railroad powered energy recovery system of claim 12 wherein each of the plurality of air compressor hoses is attached to the rail.

13. The railroad powered energy recovery system of claim 12 wherein the at least one manifold pipeline check valve is positioned between two adjacent air compressor hoses and allows passage of the compressed air in a single direction.

14. The railroad powered energy recovery system of claim 12 wherein the pneumatic motor-generator set is a pneumatic motor-generator set that generates electricity from compressed air.

15. The railroad powered energy recovery system of claim 12 wherein compressed air is stored in the storage means to produce higher pressure compressed air.

16. The railroad powered energy recovery system of claim 12 wherein each wheel of the train compresses each of the plurality of air compressor hoses to produce compressed air.

17. A method for generating electricity utilizing a railroad powered energy cogeneration system, the method comprising the steps of:
a. providing the railroad powered energy recovery system having a plurality of air compressor hoses, a plurality of manifold pipelines, at least one manifold pipeline check valve, a pneumatic air filter, a pneumatic motor-generator set, and a storage means; and
b. pushing the compressed air through the plurality of manifold pipelines to a pneumatic air outlet on at least one of the plurality of manifold pipelines.

18. The railroad powered energy cogeneration system of claim 14 wherein:
a. generating electricity from the compressed air by the pneumatic motor-generator set; and
b. storing highly-compressed air in the storage means.
